(19) United States
(12) Patent Application Publication
(10) Pub. No.: US 2005/0172825 A1
(43) Pub. Date: Aug. 11, 2005

(54) Handle-combined locking device for household bean milk and bean curd makers

(76) Inventor: Hong-bae Kim, Koyang-city (KR)

Correspondence Address: SHLESINGER, ARKWRIGHT & GARVEY LLP;Suite 600, 1420 King Street, Alexandria, VA, 22314, US

(21) Appl. No.: 10/960,750

(22) Filed: Oct. 8, 2004

(30) Foreign Application Priority Data
Oct. 8, 2003 (KR) 2003-31674

(51) Int. Cl. A23L 1/20

(52) U.S. Cl. 99/348

(57) ABSTRACT

Disclosed herein is a handle-combined locking device for household bean milk and bean curd makers. The household bean milk and bean curd maker includes a housing defining a cavity therein, and a main body provided on an upper portion of the housing to open or close the housing. The handle-combined locking device for the maker includes a handle, a locking unit, and a locking protrusion. The handle is rotatably supported on upper ends of opposite parts of a sidewall of the housing to allow a user to carry the housing. The locking unit is provided at a predetermined position on the handle, and has a locking hole. The locking protrusion is provided at a predetermined position on the main body to engage with the locking hole of the locking unit. The present invention locks the household bean milk and bean curd maker while compressing the main body and the housing against each other using the handle, thus offering a high resistance to vibration, and preventing accidents.

### CROSS-REFERENCE TO RELATED APPLICATION

This application claims priority of Korean application no. 2003-31674, filed Oct. 8, 2003, which is incorporated herein by reference.

This application relates to Applicant's concurrently filed United States application (applicant's ref. 7396), entitled “Primary Side Power Control Apparatus for Household Bean Milk and Bean Curd Maker Using High Capacity Switch”, filed Oct. 8, 2004.

This application likewise relates to Applicant's concurrently filed United States application (applicant's ref. 7401), entitled “Locking Device for Household Bean Milk and Bean Curd Makers”, filed Oct. 8, 2004.

### FIELD OF THE INVENTION

The present invention relates generally to household bean milk and bean curd makers and, more particularly, to a handle-combined locking device for the household bean milk and bean curd makers, which locks the main body to the housing of a household bean milk and bean curd maker while compressing the main body and the housing against each other using a handle, thus offering a high resistance to vibration, and preventing accidents.

### BACKGROUND OF THE INVENTION

A conventional method of making bean milk and bean curd has a problem in that several processes are individually executed, thus it is inconvenient and complicated to make bean milk and bean curd, and it takes longer time to make the bean milk and the bean curd, thereby the conventional method is inefficient.

In order to solve the problems, there have been proposed various devices for easily and conveniently making bean milk and bean curd at home. For example, there are Korean Patent No. 225772, Korean Patent No. 228659, Korean U.M. Registration No. 158856, Korean U.M. Registration No. 250843, etc, that are disclosed by the applicant of the present invention. The Korean Patent No. 225772 was published on Oct. 15, 1999, and is titled “household bean curd maker”. The Korean Patent No. 2000-228659 was published on Mar. 15, 2000, and is titled “household bean curd maker”. The Korean U.M. Registration No. 158856 was registered on Jul. 16, 1999, and is titled “household bean curd maker”. The Korean U.M. Registration No. 250843 was registered on Oct. 5, 2001, and is titled “household bean curd maker with fixed-type blade unit”.

A conventional household bean milk and bean curd maker will be described in the following with reference to the attached drawing.

FIG. 1 is a sectional view of the conventional household bean milk and bean curd maker. As shown in FIG. 1, the conventional household bean milk and bean curd maker includes a housing 1 which has a cavity to contain water therein. A main body 2 is provided on an upper portion of the housing 1 to open or close the housing 1, like a lid. A drive motor 3 is installed in a predetermined portion of the main body 2, and generates rotating power when electricity is applied to the drive motor 3. A drive shaft 4 transmits the rotating power from the drive motor 3. A cutting blade 5 is provided at an end of the drive shaft 4. A rod-shaped heater 6 downwardly extends from the main body 2, and generates heat when electricity is applied to the heater 6, thus heating an interior of the housing 1. A temperature sensing bar 7 detects the temperature of the interior of the housing 1. A filter net 8 is detachably mounted to a predetermined portion of the main body 2, and contains beans therein.

The conventional household bean milk and bean curd maker constructed as described above is operated as follows.

First, a user puts water into the housing 1. Beans are put into the filter net 8 which is detached from the main body 2, and then the filter net 8 containing the beans is mounted to the lower portion of the main body 2. Afterwards, the main body 2 is placed on the upper portion of the housing 1 so that the filter net 8 is put into the housing 1.

Next, when a power switch (not shown) is turned on to apply electricity to the household bean milk and bean curd maker, a control unit (not shown) outputs a control signal to operate the heater 6 and the temperature sensing bar 7. At this time, a primary heating process is executed while maintaining a predetermined temperature, for a predetermined period.

When the primary heating process has been completed, the control unit (not shown) outputs a control signal to operate the drive motor 3. As the drive motor 3 is operated, the beans contained in the filter net 8 are ground by the cutting blade 5 provided at the end of the drive shaft 4. While the beans are ground, turbulence of water contained in the housing 1 is caused by rotation of the cutting blade 5. By the turbulence, bean grains which are finely ground by the cutting blade 5 come out of the filter net 8. Thus, the beans ground by the cutting blade 5 are divided into bean-curd dregs which remain in the filter net 8, and the extract of protein which flows out of the filter net 8.

Thereafter, the control unit (not shown) outputs a control signal to operate the heater 6 and the temperature sensing bar 7. At this time, a secondary heating process is executed while maintaining a predetermined temperature, for a predetermined period. Through the above-mentioned process, bean milk is obtained.

When the user desires to make bean curd, the user takes the heated extract of protein out of the housing 1. Next, the coagulant is added to the heated extract of protein so as to coagulate the extract of protein. Thereafter, the coagulated protein is pressed in the frame to produce the bean curd.

However, the conventional household bean milk and bean curd maker has a problem in that excessive vibration may occur, if the maker is operated, while the main body 2 is not firmly coupled to the housing 1. Further, when the maker falls down due to the vibration, hot liquid may escape out of the maker, thus causing accidents.

### OBJECTS AND SUMMARY OF THE INVENTION

Accordingly, the present invention has been made keeping in mind the above problems occurring in the prior art, and an object of the present invention is to provide a handle-combined locking device for household bean milk and bean curd makers, which locks the main body to the housing of a household bean milk and bean curd maker while compressing the main body and the housing against each other using a handle, thus offering a high resistance to vibration, and preventing accidents.

### BRIEF DESCRIPTION OF THE DRAWINGS

FIG. 1 is a sectional view of a conventional household bean milk and bean curd maker;

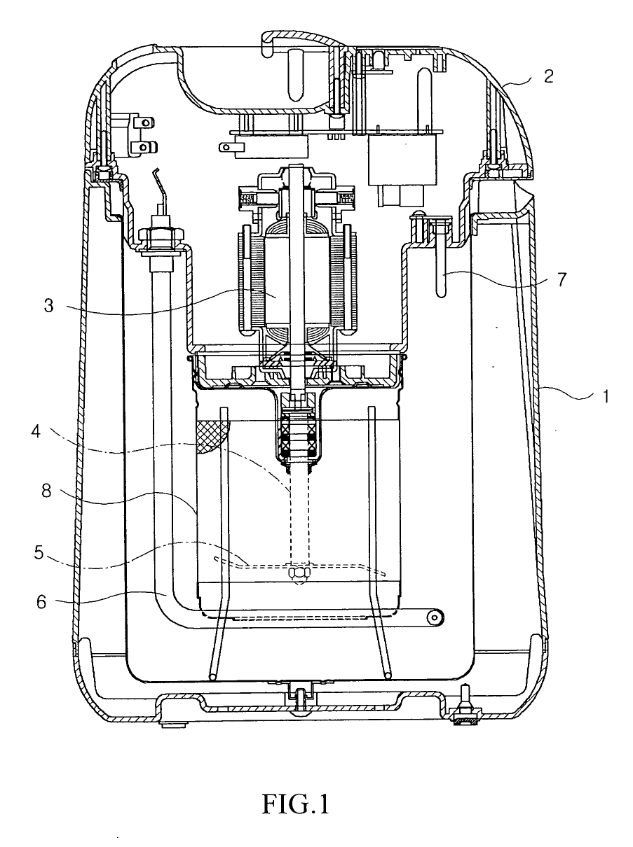

FIG. 2 is a perspective view to show a household bean milk and bean curd maker having a handle-combined locking device, according to an embodiment of the present invention, when the maker is unlocked;

FIG. 3 is a perspective view to show the household bean milk and bean curd maker having the handle-combined locking device, according to this invention, when the maker is locked; and

FIG. 4 is a sectional view taken along line A-A of FIG. 3.

### DETAILED DESCRIPTION OF THE INVENTION

Hereinafter, a preferred embodiment of the present invention will be described in detail with reference to the attached drawings so that those skilled in the art may easily implement this invention. The above and other objects, features and other advantages of the present invention will be more clearly understood from the following detailed description.

Since the preferred embodiment of the present invention has been disclosed for illustrative purposes, those skilled in the art will appreciate that various modifications, additions and substitutions are possible, without departing from the scope and spirit of the invention as disclosed in the accompanying claims.

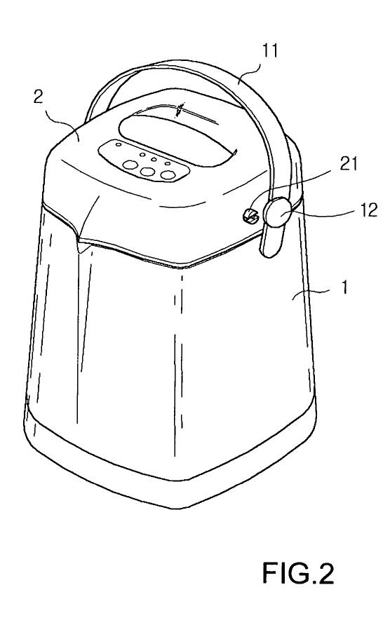

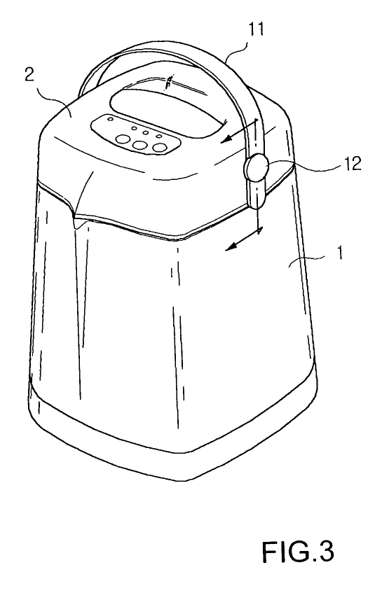

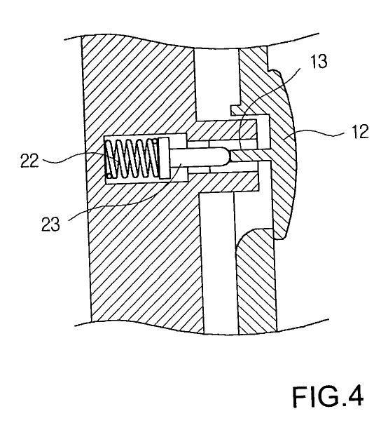

A handle-combined locking device for household bean milk and bean curd makers, according to an embodiment of the present invention, is constructed as follows. As shown in FIGS. 2 to 4, the household bean milk and bean curd maker includes a housing 1 and a main body 2. The housing 1 has a cavity therein. The main body 2 is provided on an upper portion of the housing 1 to open or close the housing 1, like a lid. The household bean milk and bean curd maker also includes a handle 11, a locking unit 12, and a locking protrusion 21. The handle 11 is rotatably supported on upper ends of opposite parts of a sidewall of the housing 1 to allow a user to carry the housing 1. The locking unit 12 is provided at a predetermined position on the handle 11, and has a locking hole. Further, the locking protrusion 21 is provided at a predetermined position on the main body 2 to engage with the locking hole of the locking unit 12.

The handle-combined locking device according to this invention further includes a locking part 13 and a compression part 23. The locking part 13 is provided at a predetermined position in the locking unit 12. The compression part 23 is provided at a predetermined position in the locking protrusion 21 to be elastically supported by a spring 22.

The handle-combined locking device for the household bean milk and bean curd maker constructed as described above is operated as follows.

When a user wishes to couple the main body 2 to the housing 1, the main body 2 is placed on the housing 1 and then the handle 11 is rotated upward. In this case, the locking protrusion 21 is pushed downward while engaging with the locking hole of the locking unit 12. Thereby, the main body 2 and the housing 1 are locked to each other while being compressed against each other.

In this case, the locking part 13 provided in the locking unit 12 compresses the compression part 23 which is elastically supported by the spring 22 in the locking protrusion 21, thus accomplishing secure locking. The compression part 23 is used as a microswitch to allow a utility AC source to be applied to the maker, when it is detected that the main body 2 is locked to the housing 1.

That is, since the locking unit 12 pushes the locking protrusion 21 downward, the housing 1 and the main body 2 are compressed against each other. Thus, even if the bean milk and bean curd maker falls down by mistake, hot contents held in the maker do not flow out of the maker, thus protecting the user from getting burnt.

Meanwhile, when the maker stops its operation, and the user desires to separate the main body 2 from the housing 1, the user rotates the handle 11 downward. At this time, the locking protrusion 21 is removed from the locking hole of the locking unit 12. As a result, the maker is unlocked.

As described above, the present invention locks a household bean milk and bean curd maker while compressing a main body and a housing against each other using a handle, thus offering a high resistance to vibration, and preventing accidents caused by hot contents of the maker.

While this invention has been described as having a preferred design, it is understood that it is capable of further modifications, and uses and/or adaptations of the invention and including such departures from the present disclosure as come within the known customary practice in the art to which the invention pertains, and as may be applied to the central features hereinbefore set forth, and fall within the scope of the invention or limits of the claims appended hereto.

1. A handle-combined locking device for household bean milk and bean curd makers each having a housing defining a cavity therein, and a main body provided on an upper portion of the housing to open or close the housing, the locking device comprising:
a) a handle rotatably supported on upper ends of opposite parts of a sidewall of the housing to allow a user to carry the housing;
b) a locking unit provided at a predetermined position on the handle, and having a locking hole; and
c) a locking protrusion provided at a predetermined position on the main body to engage with the locking hole of the locking unit.

2. The handle-combined locking device as set forth in claim 1, further comprising:
a) a locking part provided at a predetermined position in the locking unit; and
b) a compression part provided at a predetermined position in the locking protrusion to be elastically supported by a spring.

3. The handle-combined locking device as set forth in claim 2, wherein:
a) the compression part is used as a microswitch to allow a utility AC source to be applied to the household bean milk and bean curd maker, when it is detected that the main body is locked to the housing.
